(19) United States
(12) Patent Application Publication
(10) Pub. No.: US 2009/0317650 A1
(43) Pub. Date: Dec. 24, 2009

(54) CROSS-LAMINATED ELASTIC FILM

(75) Inventors: Haur-Horng Yang, Victoria, TX (US); Ping Hung Lu, Port Lavaca, TX (US); Wen Chieh Hsiao, Sugar Land, TX (US)

Correspondence Address: SENNIGER POWERS LLP, 100 NORTH BROADWAY, 17TH FLOOR, ST LOUIS, MO, 63102, US

(73) Assignee: INTEPLAST GROUP, LTD., Livingston, NJ (US)

(21) Appl. No.: 12/163,577

(22) Filed: Jun. 27, 2008

Related U.S. Application Data
(60) Provisional application No. 61/074,901, filed on Jun. 23, 2008.

(51) Int. Cl. B32B 27/32

(52) U.S. Cl. 428/523

(57) ABSTRACT

A cross-laminated film comprising at least a two layers and including a thermoplastic component and an elastic component to provide special elastic characteristics for certain packaging and wrapping applications.

### REFERENCE TO RELATED APPLICATION

This application claims priority from U.S. application 61/074,901 filed Jun. 23, 2008, the entire disclosure of which is incorporated by reference.

### FIELD OF THE INVENTION

The present invention relates to cross-laminated films for use in applications where plastic films may be used, such as stock for wrapping, sealing, and bagging.

### BACKGROUND OF THE INVENTION

In processes for packing and wrapping products such as bundles of lumber and other consumer and industrial products with plastic film, it is known to wrap a rigid film around the product and seal the plastic film tightly around the bundle by fasteners such as staples. A disadvantage of this type of process is the need to fasten the film to the bundle, and damage often occurs to the film during the wrapping and fastening operations.

A process has been developed which involves stretching a film and allowing it to snap back over a package or bundle to be wrapped whereby the film tightly grips and wraps the package or bundle. For example, where a stack of lumber 5 meters long by 3 meters wide and 3 meters tall is to be wrapped, a film is formed which approximates the stack dimensions for wrapping the stack, mechanically stretching the plastic film for example 5 to 20%, lowering the film over stack, and then releasing the film so that it snaps back and tightly grips the stack. This thereby provides a protective plastic wrap over the top and four sides of the stack.

Prior patents British 1,526,722; U.S. Pat. No. 4,629,525; and U.S. Pat. No. 5,626,944, for example, describe the production of cross-laminated films which are strong, tough, and have good tear strength in the machine and transverse direction of the film. However, these films are not elastic and are therefore not suitable for processes such as the above-described process requiring a film which can be stretched and can snap back to tightly wrap the package, bundle, or stack being wrapped.

### SUMMARY OF THE INVENTION

It is an object of the invention, therefore, to provide an elastic cross-laminated film.

Briefly, therefore, the present invention is directed to a cross-laminated film comprising at least a first layer and a second layer each comprising a thermoplastic component; and an elastic component in at least one of said first and second layers.

The invention is also directed to a cross-laminated film comprising between about 2 and about 20 weight % of an ethylene-olefin copolymer elastic polymer component, at least about 65 weight % of a thermoplastic component, and up to about 30 weight % of additive components; wherein the film has a first layer and a second layer; wherein the first layer and second layer each is a three-ply layer of three co-extruded plies of a sealing ply, a laminating ply, and a core ply sandwiched between the sealing ply and the laminating ply; the elastic polymer component is exclusively in the core ply of the first layer and the core ply of the second layer; and the laminating ply of the first layer is bonded to the laminating ply of the second layer.

Other objects and features will be in part apparent and in part pointed out hereinafter.

### BRIEF DESCRIPTION OF THE FIGURES

FIG. 1 is a cross-sectional schematic view of a laminated film of the invention.

FIGS. 2-4 are schematic views which assist in describing process steps for making the film of the invention.

### DETAILED DESCRIPTION OF THE EMBODIMENT(S) OF THE INVENTION

The present invention is directed to a cross-laminated elastic film which is strong, tough, has good tear strength in the machine direction, has good tear strength in the transverse direction, and is elastic. The film is elastic in that it can be stretched by between about 3% and about 40% in the machine direction and by between about 3% and about 24% in the transverse direction, and still snap back to its original dimensions in both directions with strong force at room temperature. No heat treatment is required to assist the film to return to its original dimensions.

The cross-laminated elastic film of the invention has a weight of between about 45 and about 500 grams per square meter (gsm), preferably between about 70 and about 200 gsm. The nominal thickness of the film is between about 50 and about 550 microns, constituted by two or more layers, each having a nominal thickness between about 25 and about 15 microns. The film in the currently preferred embodiments is manufactured in continuous lengths having a width of up to about 5 meters.

The invention achieves its unexpected properties by lamination of two or more layers. Each layer contains a thermoplastic component and optional additional components. At least one layer also contains an elastic component. Examples of suitable thermoplastic components include high-density polyethylene (HDPE), linear low-density polyethylene (LLDPE), low-density polyethylene (LDPE), polypropylene (PP), and copolymers thereof. Examples of suitable elastic components include elastic polymers (EP) such as that available from Exxon-Mobil under the trade name EXACT, and available from Dow Chemical under the trade name Affinity. These are ethylene-olefin copolymers plastomers which are available in the form of odorless opaque white pellets. The preferred polyethylene components have a density between about 0.8 and about 0.98 g/cm³ and a melt index of between about 0.01 and about 5 g/10 minutes under ASTM D 1238 and condition E. Examples of suitable elastic components include elastic polymers (EP) such as that available from Exxon-Mobil under the trade name EXACT, and available from Dow Chemical under the trade name Affinity. The preferred elastic components have a density between about 0.8 and about 0.92 g/cm³ and a melt index of between about 0.1 and about 10 g/10 minutes under ASTM D 1238 and condition E. The properties of exemplary components falling within these descriptions are provided in Table 1. The properties of exemplary components falling within these descriptions are provided in Table 1.

TABLE 1
Properties of Polyolefin

| | Density, | Melt Index, | |
|---|---|---|---|
| NAME | g/cm3 | g/10 min | Grade |
| LLDPE (1) | 0.918 | 1.00 | Exxon Exceed 1018 |
| LLDPE (2) | 0.917 | 0.90 | Formosa L62009 |
| LLDPE (3) | 0.902 | 1.00 | Dow Affinity 1880 |
| LDPE (1) | 0.921 | 0.22 | Dow 1321 |
| HDPE (1) | 0.937 | 0.30 | Formosa HF 3728 |
| HDPE (2) | 0.949 | 0.04 | Formosa E 924 |
| EP (1) | 0.870 | 1.00 | Affinity EG 8100 |
| EP (2) | 0.868 | 0.50 | Affinity EG 8150 |
| Color MB (1) | 1.160 | 32.00 | Black MB, PolyOne |
| | | | 3800 |
| Color MB (2) | 1.730 | 5-10 | White, MB, Inteplast |
| | | | N26135M |
| Slip MB | 0.940 | 4.00 | Dow Corning MB50-002 |
| Antiblock MB | 1.140 | 4.00 | Inteplast N28017A |
| Filler MB | 1.787 | 5.09 | CaCO3 MB |
| UV MB | 0.924 | 2.60 | Inteplast N26177A |

Among the optional additional components are included anti-block, slip, UV inhibitors, colorants, and fillers, and others as are known in the plastic film industry.

In one preferred embodiment of the invention comprising a first layer and a second layer, the first layer comprises up to about 20 weight % of the elastic component such as between about 2 and 20 weight % of the elastic component, between about 5 and about 20 weight % of the elastic component, or between about 5 and about 15 weight % of the elastic component. In this preferred embodiment, the first layer comprises at least about 65 weight % of the thermoplastic component, such as between about 70 and about 95 weight % of the thermoplastic component, between about 70 and about 90 weight % of the thermoplastic component, or between about 70 and about 85 weight % of the thermoplastic component. The first layer also optionally contains up to about 30 weight % of other additive components such as the color, slip, etc. components described above, for example between about 5 and about 25 weight % of such components. The proportions of the constituents of the second layer are typically distinct from the proportions in the first layer, though the proportions in the second layer also preferably fall within these same ranges. Moreover, the proportions of the constituents of both layers cumulatively, or all layers if more than two layers are employed, preferably fall within these same ranges.

In one preferred embodiment, the two layers described above are each three-ply layers. That is, there are three plies within each of the major layers of material used in forming the laminated films of the invention. These plies constitute a core component, a sealing component, and a laminating component as described in U.S. Pat. No. 4,629,525, and are co-extruded as described in British Pat. 1,526,722, the entire disclosures of which are incorporated by reference.

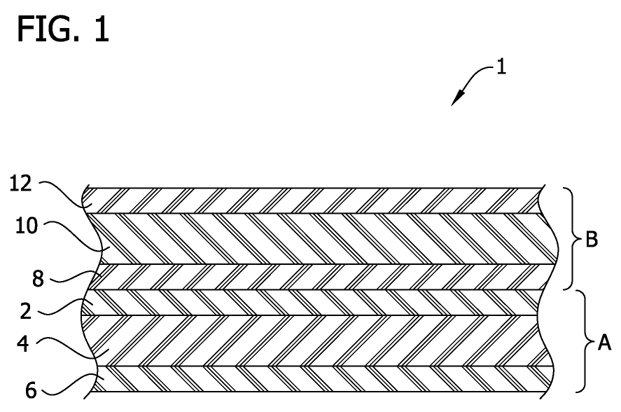

As shown schematically in FIG. 1 of the present application, in film 1 the lamination ply 2 of the first layer A and the lamination ply 8 of the second layer B are designed to face and contact each other as the first and second layers A and B are laminated together. The lamination plies 2 and 8 are formulated so that the two layers A and B can be easily and strongly bond together under pressure. The core plies 4 and 10 are the central ply of each layer, and provide the strength and the mechanical properties of the film 1. The seal plies 6 and 12, which are the outer plies of the eventual film product 1, are formulated for easy sealing in converting to bags or other products. So in the ultimate laminated film 1, the bottom ply 6 is the sealing ply 6 of the first layer A, on top of that is the core ply 4 of the first layer A, on top of that is the laminating ply 2 of the first layer A, on top of that is the laminating ply 8 of the second layer B, on top of that is the core ply 10 of the second layer B, and on top of that is the seal ply 12 of the second layer B. As described in column 8 of the '525 patent, the core component or “main layer” exhibits a fibrillar grain structure and exhibits a predominant direction of splittability. The laminating component or “second layer” controls bonding strength between the two films being laminated together. And the sealing layer is a “surface layer which facilitates sealing of the laminate.”

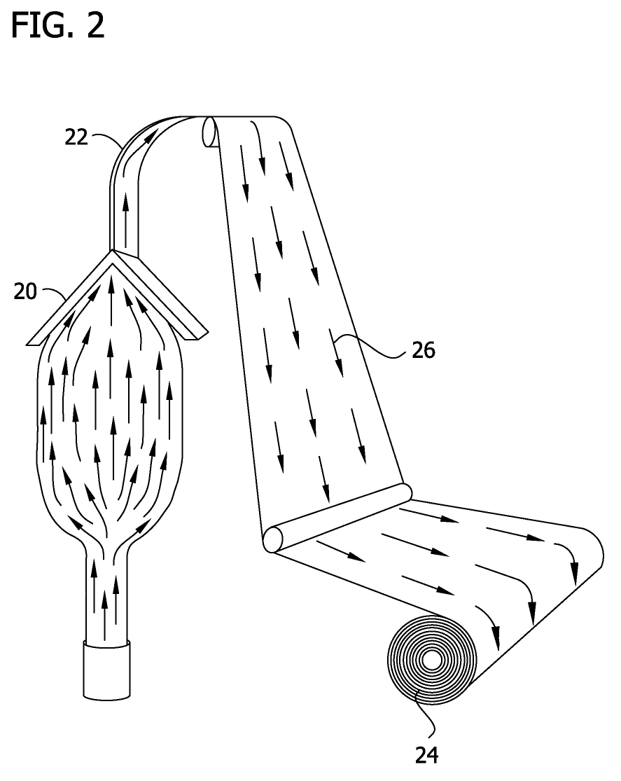

As shown schematically in FIG. 2, the three components or plies—sealing, core, and laminating—are coextruded through a blown film process 20 to yield a film layer 22 which corresponds to a layer A or layer B which will eventually be laminated together. Three extruders within 20 extrude the thermoplastic materials with the formulae of seal, core, and lamination plies into a co-extrusion die. The thermoplastic materials of the three plies are heat-bounded in the co-extrusion die to form a film tube. The film tube is then blown and enlarged into a bigger film tube, which is later collapsed in a tenter and wound into a roll. The process is called blown film process 20, which is common in the industry. Co-extrusion of three plies is known, for example, from British Pat. 1,526,722, the entire disclosure of which is incorporated by reference. Film layer 22 exhibits a molecular structure with predominant direction of splittability or major direction of orientation shown by arrows 26. Film layer 22 is gathered onto roll 24.

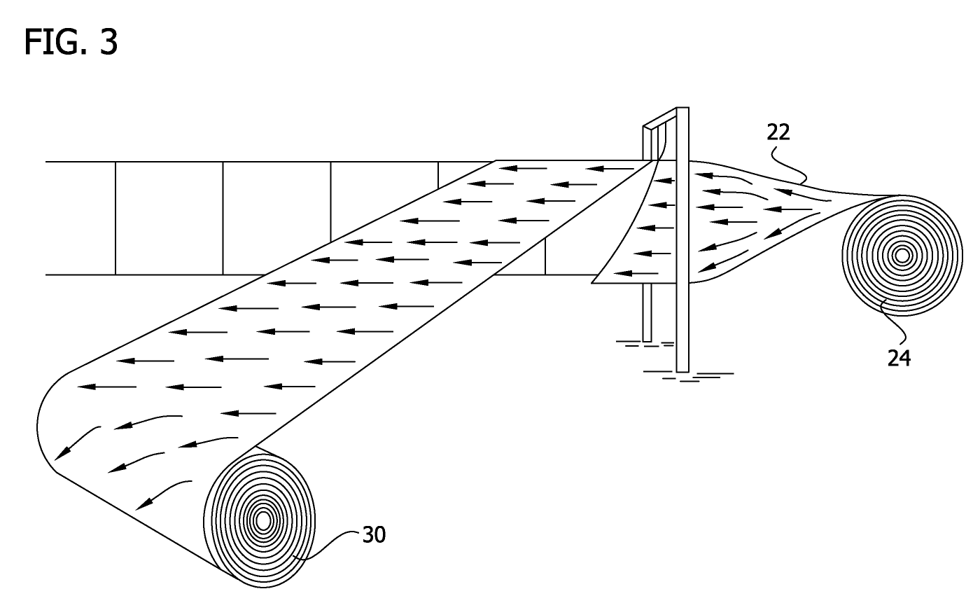

As shown schematically in FIG. 3, layer 22 from roll 24 is processed to yield a film in which the major direction of orientation is re-aligned so that it is at an angle with respect to the machine direction rather than corresponding to the machine direction. The collapsed film tube roll 24 from the blown film process 20 is formed into a tube by a drum. A knife with the desired cutting angle slits the film tube into single-layer film (not tube anymore). The film is wound into film roll 30. This is accomplished in the manner described in the British Pat. 1,526,722; U.S. Pat. No. 4,629,525. This yields roll 30 containing a film in which the major direction of orientation is at an angle with respect to the length direction of the film. That is, the film has a major direction of orientation on roll 24 which corresponds to the length direction of the film. And the film is processed as shown in FIG. 3 to yield a film in which the major direction of orientation is at an angle of between about 30 and 60 degrees, such as about 45 degrees, with respect to the length direction of the film.

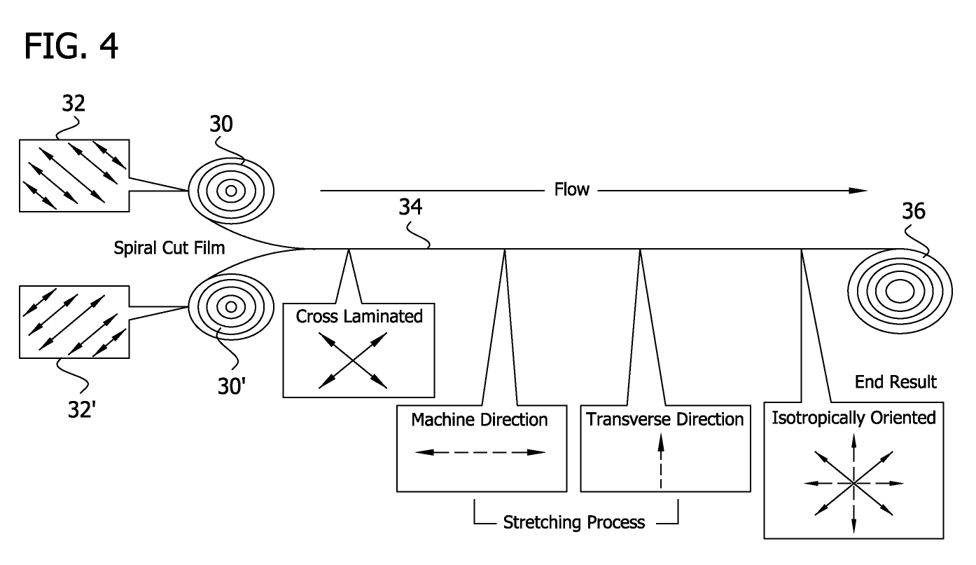

Two films 30 and 30′ as produced according to FIG. 3 are then laminated together as shown in FIG. 4. The major direction of orientation as shown in 32, 32′ is at an angle with respect to the length direction of each film. These films are then laminated together as shown and as explained in U.S. Pat. Nos. 4,629,525 and 5,626,944, both of which are incorporated by reference and demonstrate what has become the level of skill in the art. The laminated film 34 is stretched as disclosed in these prior patents. At least two film rolls 30 with opposite cutting angles are laminated together and stretched in both machine and transverse directions with several sets of press rolls to form cross laminated XF film 36. Some sets of the rolls have grooves, which stretch the XF film in the transverse direction. Some sets of rolls have speed difference to stretch the film in machine direction. Finally, the laminated XF film has to be annealed with some sets of rolls to release the internal stress built in the film during the stretching process. A regular blown film has weakness in either machine or transverse direction. Since the cross-laminated film is laminated by at least two layers of films with opposite cutting angles, the film of one layer can cover the weakness of film of the other layer(s). Here the laminated film is also processed to yield a strengthened undulating structure of convex and concave surfaces as described in U.S. Pat. No. 5,626,944. The film is laminated and stretched in the transverse direction with rolls having small grooves. The undulating structure is not optional but the result of the lamination and stretching. The product as shown on the right in FIG. 4 has two layers with major directions of orientation which criss-cross each other, and which are at an angle with respect to the machine direction, i.e., the direction of travel of the film toward and into roll 36.

Returning now to description of the individual film or layer 22, the core component preferably constitutes between about 45 and about 90%, such as between about 55% and about 80% by weight of the layer. The core component contains a thermoplastic component and an elastic component. In one preferred embodiment, the core component comprises between about 50 and about 95 weight %, such as between about 70 and about 95 weight %, between about 80 weight % and about 90 weight %, or between about 70 and about 90 weight % of a thermoplastic component, and between about 5 weight % and about 30 weight %, such as between about 10 weight % and about 25 or 20 weight %, of an elastic component. The core component may optionally contain up to about 25 weight % cumulatively of additive components such as the above-described color and UV components.

The sealing component preferably constitutes between about 5 and about 30 or 40%, such as between about 10% and about 25 or 30% by weight of the layer. The sealing component contains a thermoplastic component. In one preferred embodiment, the sealing component comprises between about 75 and about 95 or 100 weight %, such as between about 80 weight % and about 90 or 95 weight %, of a thermoplastic component and up to about 25 weight % cumulatively of additive components such as the above-described color and UV components.

The laminating component preferably constitutes between about 5 and about 20 or 25% by weight, such as between about 5 and about 15 or 20 weight %, of the layer. The laminating component contains a thermoplastic component. In one preferred embodiment, the laminating component comprises between about 90 or 95 and about 100 weight % of a thermoplastic component and up to about 5 or 10 weight % cumulatively of additive components such as the above-described antiblock component. The components in the formula are weighed and mixed and then transported to the hoppers of the extruders.

### Example 1

Two layers Layer A and Layer B were prepared according to the compositions of Table 2. All percentages herein are by weight.

TABLE 2. Formulae of Example 1

TABLE 2
Formulae of Example 1

| | MATERIAL | SEALING | CORE | LAMINAT. | CUM. |
|---|---|---|---|---|---|
| | NAME | 15% | 75% | 10% | 100% |
| Layer A | LLDPE (2) | | 20 | 33 | 18.3 |
| | LLDPE (1) | 59 | 50 | | 46.35 |
| | LDPE (1) | | 9 | | 6.75 |
| | HDPE (1) | 30 | | | 4.5 |
| | Color MB (1) | 6 | 5 | | 4.65 |
| | EP (2) | | 16 | | 12 |
| | Antiblock MB | | | 2 | 0.2 |
| | Slip MB | 5 | | | 0.75 |
| | LLDPE (3) | | | 65 | 6.5 |
| | MATERIAL | SEALING | CORE | LAMINAT. | CUM. |
| | NAME | 25% | 65% | 10% | 100% |
| Layer B | LLDPE (2) | | 20 | 33 | 16.3 |
| | LLDPE (1) | 76 | 41 | | 45.65 |
| | UV MB | 2 | 2 | | 1.8 |
| | LDPE (1) | 5 | 8 | | 6.45 |
| | Color MB (2) | 15 | 15 | | 13.5 |
| | EP (2) | | 14 | | 9.1 |
| | Antiblock MB | 2 | | 2 | 0.7 |
| | LLDPE (3) | | | 65 | 6.5 |

From Table 2 it should therefore be understood that the sealing component of Layer A constituted 15% by weight of Layer A, the core component constituted 75% by weight of Layer A, and the laminating component constituted the remaining 10% by weight of Layer A. Furthermore, the sealing component comprised 59% by weight of LLDPE (1), 30% by weight of HDPE (1), 6% by weight of Color MB (1), and 5% by weight of Slip MB. This same convention applies to reading the tables for the other layers and components thereof of all the examples.

Layer A therefore contained 12% of the elastic component (EP), 82.4% of the thermoplastic component (LLDPE, LDPE, HDPE), and 5.6% of the other additives.

Layer B contained 9.1% of the elastic component, 74.9% of the thermoplastic component, and 16% of the other additives.

Layers A and B were laminated together to produce a cross-laminated film.

### Example 2

Two layers Layer A and Layer B were prepared according to the compositions of Table 3.

TABLE 3. Formulae of Example 2

TABLE 3
Formulae of Example 2

| | MATERIAL | SEALING | CORE | LAMINAT. | CUM. |
|---|---|---|---|---|---|
| | NAME | 30% | 60% | 10% | 100% |
| Layer A | LLDPE (2) | | 20 | 33 | 15.3 |
| | LLDPE (1) | 86 | 54 | | 58.2 |
| | Color MB (2) | | 10 | | 6 |
| | Color MB (1) | 10 | | | 3 |
| | EP (1) | | 16 | | 9.6 |
| | Antiblock MB | 4 | | 2 | 1.4 |
| | LLDPE (3) | | | 65 | 6.5 |
| | MATERIAL | SEALING | CORE | LAMINAT. | CUM. |
| | NAME | 25% | 65% | 10% | 100% |
| Layer B | LLDPE (2) | | 20 | 33 | 16.3 |
| | LLDPE (1) | 86 | 52 | | 55.3 |
| | UV MB | 2 | 2 | | 1.8 |
| | Color MB (2) | 10 | 10 | | 9 |
| | EP (1) | | 16 | | 10.4 |
| | Antiblock MB | 2 | | 2 | 0.7 |
| | LLDPE (3) | | | 65 | 6.5 |

Layer A therefore contained 9.6% of the elastic component (EP), 80% of the thermoplastic component (LLDPE), and 10.4% of the other additives. Layer B contained 10.4% of the elastic component, 78.1% of the thermoplastic component, and 11.5% of the other additives.

Layers A and B were laminated together to produce a cross-laminated film.

### Comparative Example 3

Two layers Layer A and Layer B were prepared according to the compositions of Table 4.

### Table 3. Formulae of Comparative Example 3

TABLE 4
Formulae of Comparative Example 3

| | MATERIAL | SEALING | CORE | LAMINAT. | CUM. |
|---|---|---|---|---|---|
| | NAME | 20% | 70% | 10% | 100% |
| Layer A | LLDPE (2) | 50 | | 35 | 13.5 |
| | HDPE (2) | | 76 | | 53.2 |
| | Color MB (1) | 8 | 4 | | 4.4 |
| | HDPE (1) | 42 | 20 | | 22.4 |
| | LLDPE (3) | | | 65 | 6.5 |
| | MATERIAL | SEALING | CORE | LAMINAT. | CUM. |
| | NAME | 20% | 70% | 10% | 100% |
| Layer B | LLDPE (1) | 50 | | 35 | 13.5 |
| | HDPE (2) | | 64 | | 44.8 |
| | UV MB | | 2 | | 1.4 |
| | HDPE (1) | 40 | 20 | | 22 |
| | Color MB (2) | 10 | 10 | | 9 |
| | Filler MB | | 4 | | 2.8 |
| | LLDPE (3) | | | 65 | 6.5 |

Layer A therefore contained 95.6% of the thermoplastic component (LLDPE, HDPE) and 4.4% of other additives. Layer B contained 86.8% thermoplastic component and 13.2% of other additives.

Layers A and B were laminated together to produce a cross-laminated film.

### Example 4

Various properties of the laminated films of the preceding examples were tested and are presented in Table 5.

TABLE 5. Properties of Films

TABLE 5
Properties of Films

| | Test | | | Comparative | Comparative | Comparative |
|---|---|---|---|---|---|---|
| Property | Direction | Example 1 | Example 2 | Example 3 | Example 4 | Example 5 |
| NOMINAL THICKNESS | | 112 | 103 | 95 | 133 | 130 |
| (microns) | | | | | | |
| TENSILE @ ULT | MD | 21.20 | 18.83 | 21.66 | 15.79 | 16.23 |
| (lbs/in) (ASTM D882) | TD | 20.60 | 17.47 | 17.24 | 15.07 | 15.04 |
| ELONGATION @ULT | MD | 710.0 | 668.9 | 561.7 | 784.7 | 783.8 |
| (%) (ASTM D882) | TD | 668.5 | 615.1 | 541.9 | 821.1 | 892.7 |
| DART IMPACT (grams) | | 1989 | 1766 | 443 | 917 | 710 |
| (ASTM D1709 Method A) | | | | | | |
| ELMENDORF TEAR | MD | 4,271 | 4,158 | 1,711 | 2,727 | 2,025 |
| (grams) (ASTM D1922) | TD | 4,009 | 4,210 | 1,664 | 2,045 | 2,635 |
| PUNCTURE-PROP. TEAR | MD | 10,690 | 8,711 | 7,529 | 7,957 | 8,297 |
| (grams) Sled: 1 lb (ASTM | TD | 10,910 | 9,570 | 7,991 | 8,475 | 8,832 |
| D2582) | | | | | | |
| Remain Force after 2 minutes | MD | 75.00% | 75.00% | 66.00% | N/A | N/A |
| (5% stretched) | | | | | | |

These data show that the Elmendorf tear strengths of the films of Examples 1 and 2 of the invention in both the machine direction (MD) and transverse direction (TD) are greater than about 3000 grams, and even greater than about 4000 grams, and far superior to that of the Comparative Examples. Comparative Examples 4 and 5 are commercially available films made by a traditional blown film process. Furthermore, the puncture-propogation tear strengths of the films of Examples 1 and 2 in both the machine and transverse directions are superior to that of the Comparative Examples. The dart impact strengths of the films of the invention were far superior to that of the Comparative Examples. The “Remain Force” test in Table 5 demonstrates that after stretching the films of the invention 5% in the machine direction and holding there for two minutes, the films of the invention retained 75% of their pull-back strength. Comparative Example 3 only retained 66% of its pull-back strength. The films of the invention also maintained good mechanical strength, as demonstrated by the tensile and elongation data.

### Example 5

The films of Examples 1 and 2 were tested by being stretched over 10% in the machine direction over a package. After stretching over 10% and placement over a package, the films snapped back to tightly wrap the package. A film of Comparative Example 3 was subject to the same test and did not snap back to tightly wrap the package.

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

What is claimed is:

1. A cross-laminated film comprising:
at least a first layer and a second layer bonded to each other and each comprising a thermoplastic component; and
an elastic polymer component in at least one of said first and second layers.

2. The cross-laminated film of claim 1 wherein both the first layer and the second layer each have an elastic polymer component and a thermoplastic component.

3. The cross-laminated film of claim 1 wherein the first and second layers are co-extruded layers each comprising at least three plies.

4. The cross-laminated film of claim 2 wherein the first and second layers are co-extruded layers each comprising at least three plies.

5. The cross-laminated film of claim 1 wherein the first and second layers are co-extruded layers each comprising three plies.

6. The cross-laminated film of claim 2 wherein the first and second layers are co-extruded layers each comprising three plies.

7. The cross-laminated film of claim 4 wherein the three plies comprise a sealing ply comprising at least about 75 weight % of a sealing-ply thermoplastic component, a core ply comprising between about 50 and about 95 weight % of a core-ply thermoplastic component and between about 5 and about 30 weight % of a core-ply elastic polymer component, and a laminating ply comprising between about 90 and 100 weight % of a laminating-ply thermoplastic component.

8. The cross-laminated film of claim 1 wherein:
the first layer is a three-ply layer of three co-extruded plies of a sealing ply, a laminating ply, and a core ply sandwiched between the sealing ply and the laminating ply; and
said elastic polymer component is exclusively in said core ply.

9. The cross-laminated film of claim 1 wherein:
the first layer and second layer each is a three-ply layer of three co-extruded plies of a sealing ply, a laminating ply, and a core ply sandwiched between the sealing ply and the laminating ply; and
said elastic polymer component is exclusively in the core ply of the first layer and the core ply of the second layer.

10. The cross-laminated film of claim 1 wherein:
the first layer and second layer each is a three-ply layer of three co-extruded plies of a sealing ply, a laminating ply, and a core ply sandwiched between the sealing ply and the laminating ply;
the elastic polymer component is exclusively in the core ply of the first layer and the core ply of the second layer; and
the laminating ply of the first layer is bonded to the laminating ply of the second layer.

11. The cross-laminated film of claim 1 wherein:
the first layer and second layer each is a three-ply layer of three co-extruded plies of between about 5 and about 30 weight % of a sealing ply, between about 5 and about 25 weight % of a laminating ply, and between about 45 and about 90 weight % of a core ply sandwiched between the sealing ply and the laminating ply;
the elastic polymer component is exclusively in the core ply of the first layer and the core ply of the second layer; and
the laminating ply of the first layer is bonded to the laminating ply of the second layer.

12. The cross-laminated film of claim 1 wherein:
the first layer and second layer each is a three-ply layer of three co-extruded plies of between about 10 and about 25 weight % of a sealing ply, between about 5 and about 20 weight % of a laminating ply, and between about 55 and about 80 weight % of a core ply sandwiched between the sealing ply and the laminating ply;
the elastic polymer component is exclusively in the core ply of the first layer and the core ply of the second layer; and
the laminating ply of the first layer is bonded to the laminating ply of the second layer.

13. The cross-laminated film of claim 1 wherein the elastic polymer component is an ethylene-olefin copolymer.

14. The cross-laminated film of claim 1 wherein the first layer has a major direction of molecular orientation which criss-crosses a major direction of orientation of the second layer, and wherein both the first layer major direction of orientation and the second layer major direction of orientation are at an angle with respect to a length direction of the film.

15. A cross-laminated film comprising:
between about 2 and about 20 weight % of an ethylene-olefin copolymer elastic polymer component, at least about 65 weight % of a thermoplastic component, and up to about 30 weight % of additive components;
wherein the film has a first layer and a second layer;
wherein the first layer and second layer each is a three-ply layer of three co-extruded plies of a sealing ply, a laminating ply, and a core ply sandwiched between the sealing ply and the laminating ply;
the elastic polymer component is exclusively in the core ply of the first layer and the core ply of the second layer; and
the laminating ply of the first layer is bonded to the laminating ply of the second layer.

16. The cross-laminated film of claim 15 wherein the first layer and second layer each is said three-ply layer of three co-extruded plies of between about 10 and about 25 weight % of the sealing ply, between about 5 and about 20 weight % of the laminating ply, and between about 55 and about 80 weight % of the core ply sandwiched between the sealing ply and the laminating ply.

17. The cross-laminated film of claim 15 wherein the sealing ply of each layer comprises at least about 75 weight % of a sealing-ply thermoplastic component, the core ply of each layer comprises between about 50 and about 95 weight % of a core-ply thermoplastic component and between about 5 and about 30 weight % of a core-ply elastic polymer component, and the laminating ply of each layer comprises between about 90 and 100 weight % of a laminating-ply thermoplastic component.

18. The cross-laminated film of claim 16 wherein the sealing ply of each layer comprises at least about 75 weight % of a sealing-ply thermoplastic component, the core ply of each layer comprises between about 50 and about 95 weight % of a core-ply thermoplastic component and between about 5 and about 30 weight % of a core-ply elastic polymer component, and the laminating ply of each layer comprises between about 90 and 100 weight % of a laminating-ply thermoplastic component.

19. The cross-laminated film of claim 15 wherein the first layer has a major direction of molecular orientation which criss-crosses a major direction of orientation of the second layer, and wherein both the first layer major direction of orientation and the second layer major direction of orientation are at an angle with respect to a length direction of the film.

20. The cross-laminated film of claim 18 wherein the first layer has a major direction of molecular orientation which criss-crosses a major direction of orientation of the second layer, and wherein both the first layer major direction of orientation and the second layer major direction of orientation are at an angle with respect to a length direction of the film.
